(19) United States
(12) Patent Application Publication
(10) Pub. No.: US 2011/0042528 A1
(43) Pub. Date: Feb. 24, 2011

(54) Interface adapter connector for effectively connecting a seismic sway brace or restraint pipe to a support anchor

(75) Inventors: Kevin M. Tucker, Chicago, IL (US); Louis Thomas, Maywood, IL (US); Cheryl L. Panasik, Elburn, IL (US); Robert B. Fischer, Roselle, IL (US)

Correspondence Address: Steven W. Weinrieb;LAW OFFICES OF STEVEN W. WEINRIEB, 8717 Cold Spring Road, Potomac, MD, 20854, US

(73) Assignee: ILLINOIS TOOL WORKS INC.

(21) Appl. No.: 12/461,700

(22) Filed: Aug. 21, 2009

(51) Int. Cl. F16L 3/00

(52) U.S. Cl. 248/62

(57) ABSTRACT

An interface adaptor connector for effectively connecting one end of a seismic sway brace or restraint pipe, which is fixedly connected to, for example, a water pipe of a building sprinkler system, to a suitable support anchor which is adapted to be fixedly connected to an overhead ceiling or structural beam member of a building within which a sprinkler system has been installed.

### FIELD OF THE INVENTION

The present invention relates generally to seismic sway brace or restraint systems, and more particularly to a new and improved interface adaptor connector for effectively connecting one end of a seismic sway brace or restraint pipe, which is fixedly connected to, for example, a water pipe of a building sprinkler system, to a suitable support anchor which is adapted to be fixedly connected to an overhead ceiling or structural beam member of a building within which a sprinkler system has been installed.

### BACKGROUND OF THE INVENTION

Various different devices or products are well known in the building and plumbing industries and are used in connection with the bracing, restraining, or otherwise stabilizing water pipes used in connection with, for example, sprinkler systems installed within commercial or industrial buildings. The devices or products are used to brace, restrain, or stabilize the water pipes with respect to the building's ceiling or structural beam members so as to effectively protect such water and sprinkler systems from undergoing undesirable movements if, for example, the water pipe and sprinkler systems should be subjected to various forces that may effectively be impressed upon the water pipe and sprinkler system during, for example, a naturally occurring seismic event, such as an earthquake, or during a man-made event, such as, for example, an explosion. Pipes or rods are the most commonly used structures for performing the actual bracing, restraining, or stabilizing of the water pipes with respect to the building's ceiling or structural beam members, wherein a first end of the bracing, restraining, or stabilizing pipe or rod is effectively and fixedly connected to each water pipe by means of a suitable encircling mounting strap, and a turnbuckle assembly, or the like, while the second opposite end of the bracing, restraining, or stabilizing pipe or rod is effectively and fixedly connected to the ceiling or structural beam member by means of a suitable anchor.

More particularly, for example, with reference firstly being made to FIGS. 1 and 2, a conventional system for bracing, restraining, or otherwise stabilizing a water pipe used in connection with, for example, a sprinkler system that has been installed within a commercial or industrial building is disclosed and is generally indicated by the reference character 100. It is to be noted that while the conventional bracing, restraining, or stabilizing system 100 has been illustrated with respect to, and is fixedly mounted upon, a framework 102, the framework 102 has been erected solely for demonstration and testing purposes, the upper frame member 104 of the framework 102 effectively simulating the ceiling or structural beam member of a building within which the system 100 is to be installed. A water pipe 106 is provided for supplying water to the multitude of water sprinkler heads, one of which is illustrated within FIG. 1 at 108, and it is seen that the water pipe 106 is suspendingly connected to the upper frame member 104, or other support means, of the framework 102 by means of a plurality of externally threaded suspension rods 110. A plurality of suitable suspension straps 112 are disposed in an encircling manner about the water pipe 106 at axially spaced positions along the water pipe 106, and it is seen that each externally threaded suspension rod 110 operatively cooperates with a nut member 114 or the like such that each externally threaded suspension rod 110, its nut member 114, and its operatively associated suspension strap 112 effectively comprises a turnbuckle assembly whereby the lower end portion of each one of the suspension rods 110 is effectively forced into tight engagement with the external peripheral surface portion of the water pipe 106 such that the water pipe 106 cannot undergo any movement within, and relative to, its operatively associated suspension strap 112. The upper ends of the externally threaded suspension rods 110 are fixedly connected to suitable anchor members 116 fixedly mounted within the upper frame member 104 or similar support means of the framework 102 which, again, simulate a building's ceiling or structural beam member

In a similar manner, a plurality of bracing, restraining, or stabilizing rods 118 are similarly connected to the water pipe 106, by means of encircling attachment strap members 120, similar to the suspension straps 112, disposed at predetermined axial positions along the water pipe 106, and nut members 122 similar to the nut members 114, are operatively associated with the encircling straps members 120 so as to effectively form similar turnbuckle assemblies for ensuring that the lower end portions of the bracing, restraining, or stabilizing rods 118 are tightly engaged against the outer peripheral surface portions of the water pipe 106 such that the water pipe 106 cannot undergo any movement within, and relative to, each one of the operatively associated attachment strap members 120. The upper end portions of the bracing, restraining, or stabilizing rods 118 are adapted to be fixedly connected to the upper frame member 104, or similar support means of the framework 102, by means of suitable anchor members 124 similar to the anchor members 116. In this manner, it can be appreciated that without the presence of the various bracing, restraining, or stabilizing rods 118, the water pipe 106 could effectively undergo lateral or arcuate movements with respect to the building ceiling or beam structures, around pivot points effectively defined at those locations at which the upper end portions of the suspension rods 110 are fixedly connected to the building ceiling or beam structure, if, for example, the system 100 was subjected to seismic or other types of events which could impress powerful external forces upon the system 100.

It is important that the bracing, restraining, or stabilizing pipe or rod be fabricated from a suitable material, and be of sufficient diametrical extent, so as to exhibit the necessary strength and rigidity required to withstand the various forces that may be effectively impressed upon the water pipe system during, for example, a naturally occurring seismic event, such as an earthquake, or during, for example, a man-made event, such as, for example, an explosion. For example, in accordance with the conventional bracing, restraint, or stabilizing system 100 as illustrated within FIGS. 1 and 2, solid rods, fabricated from a suitable steel material, and having a diametrical ex-tent of, for example, either three-eighths of an inch (0.375″) in diameter, or one-half of an inch (0.50″) in diameter, have been used as the bracing, restraining, or stabilizing rods 118. However, it has been discovered, through means of suitable testing procedures, that the noted bracing, restraining, or stabilizing rods 118, having the noted diametrical extents of, for example, either three-eighths of an inch (0.375″) in diameter, or one-half of an inch (0.50″) in diameter, have in fact been unsatisfactory in connection with the requisite bracing, restraining, or stabilizing of the water pipes 106. In other words, even with the installation or use of the bracing, restraining, or stabilizing rods 118 in conjunction with the water pipes 106, such bracing, restraining, or stabilizing rods 118 did not in fact prevent the swaying, lateral, or arcuate movements of the water pipes 106 under simulated naturally occurring seismic conditions, attendant, for example, an earthquake, or under simulated man-made conditions, such as, for example, an explosion.

Accordingly, there is a need in the art for a bracing, restraining, or stabilizing structural member, which may either be a solid rod or a hollow pipe, wherein the same can exhibit enhanced structural rigidity and bending resistance characteristics so as to in fact prevent the water pipes from undergoing any swaying, lateral, or arcuate movements of the water pipes under simulated naturally occurring seismic or earthquake conditions, or similarly under man-made conditions, such as, for example, an explosion. Such enhanced structural rigidity and bending resistance characteristics have in fact been able to be achieved by using, in lieu of the solid rods 118, fabricated from a suitable steel material and having a diametrical extent of, for example, three-eighths of an inch (0.375″) in diameter, or alternatively having a diametrical extent of one-half of one inch (0.50″) in diameter, requisite bracing, restraining, or stabilizing pipes having a diametrical extent of approximately one inch in diameter. The problem with employing such larger pipe structures resides in effectively fixedly connecting the same to the ceiling or beam structures of the building within which the water sprinkler systems are to be installed. An additional need therefore exists in the art to operatively fixedly connect the upper end portions of such bracing, restraining, or stabilizing pipes to suitable anchor members, fixedly mounted within the ceiling or beam structures of the building, in a relatively easy, simple, and cost-effective manner.

Examples of sway brace fittings or connectors are disclosed within U.S. Pat. No. 7,441,730 which issued to Heath on Oct. 28, 2008, U.S. Pat. No. 7,191,987 which issued to Heath on Mar. 20, 2007, U.S. Pat. No. 6,953,174 which issued to Heath on Oct. 11, 2005, U.S. Pat. No. 6,708,930 which issued to Heath on Mar. 23, 2004, U.S. Pat. No. 6,517,030 which issued to Heath on Feb. 11, 2003, and U.S. Pat. No. 6,273,372 which issued to Heath on Aug. 14, 2001. However, while the afore-noted fittings or connectors have been satisfactory, they consist of multiple components wherein such components must, of course, be individually manufactured, comprising various machining, drilling, and threading operations, and wherein further, the various components must of course be subsequently assembled together.

A need therefore exists in the art for a new and improved interface adaptor connector, for effectively connecting an end portion of a seismic sway brace or restraint pipe, which is fixedly connected at its other end to, for example, a water pipe of a building sprinkler system, to a suitable support anchor that is adapted to be fixedly connected to an overhead ceiling or structural beam member of the building within which the water sprinkler system has been installed, in a relatively easy, simple, and cost-effective manner.

### SUMMARY OF THE INVENTION

The foregoing and other objectives are achieved in accordance with the teachings and principles consistent with the present invention through the provision of a new and improved interface adaptor connector, for effectively connecting an end of a seismic sway brace or restraint pipe, which is fixedly connected at its other end to, for example, a water pipe of a building sprinkler system, to a suitable support anchor which is adapted to be fixedly connected to an overhead ceiling or structural beam member of a building within which the water sprinkler system has been installed, in a relatively easy, simple, and cost-effective manner. The new and improved interface adaptor connector comprises a cap member which can mate with the free or distal end of the bracing, restraining, or stabilizing pipe, and wherein further, the cap member is provided with a stud or bolt which can mate with an anchor adapted to be fixedly mounted or secure within the building ceiling or support beam structure. Alternatively, in lieu of the cap member, a support strapping or bracket member can be utilized.

### BRIEF DESCRIPTION OF THE DRAWINGS

Various other features and attendant advantages consistent with the present invention will be more fully appreciated from the following detailed description when considered in connection with the accompanying drawings in which like reference characters designate like or corresponding parts throughout the several views, and wherein:

FIG. 1 is a perspective view of a conventional system for bracing, restraining, or stabilizing a water pipe, the could be used in connection with a sprinkler system that could be installed within a commercial or industrial building, wherein the system is mounted upon a demonstration or testing framework which simulates a building's ceiling or a structural beam member thereof;

FIG. 2 is an enlarged perspective view of the bracing, restraining, or stabilizing system, as disclosed within FIG. 1, clearly illustrating the interoperative cooperation between the water pipe suspension members and the water pipe bracing, restraining, or stabilizing members, with respect to the simulated building's ceiling or structural beam member;

FIG. 3 is a perspective plan view of a first embodiment of an interface adaptor connector in the form of a first internally threaded cap member and its operatively association with an externally threaded end portion of a bracing, restraining, or stabilizing pipe, wherein the cap member has an externally threaded bolt projecting outwardly therefrom for engagement with an anchor assembly;

FIG. 4 is an enlarged plan view of the structural components illustrated within FIG. 3 wherein the first cap member has been turned so as to better view the internally threaded portion thereof;

FIG. 5 is a side elevational view of the assembly comprising the first cap member and the threaded bolt as shown within FIGS. 3 and 4;

FIG. 6 is a cross-sectional view of the assembly comprising the first cap member and the threaded bolt, as illustrated within FIG. 5 and as taken along the lines 6-6 of FIG. 5, clearly showing the threaded mating of the bolt member within the domed portion of the first cap member;

FIG. 7 is a perspective view of the assembly comprising the first cap member and the threaded bolt, and corresponding to the mated structural assembly shown in FIGS. 5 and 6;

FIG. 8 is a side elevational view of the assembled bracing, restraining, or stabilizing pipe, the first internally threaded cap member threadedly connected onto the externally threaded end portion of the bracing, restraining, or stabilizing pipe, and the externally threaded bolt member projecting outwardly from the bracing, restraining, or stabilizing pipe and threadedly connected to a second cap or nut member of a fastener or anchor assembly;

FIG. 8a is a side elevational view of a conventional anchor assembly which may be used in conjunction with the various embodiments of the interface adaptor connector of the present invention;

FIG. 9 is a side elevational view, similar to that of FIG. 5, showing, however, a second embodiment of an interface adaptor connector which comprises a first cap member;

FIG. 10 is a cross-sectional view, similar to that of FIG. 6, showing, however, the second embodiment of the first cap member of FIG. 9 as taken along lines 10-10 of FIG. 9;

FIG. 11 is a side elevational view of a third embodiment of an interface adaptor connector which comprises a first cap member which is unthreaded and which is adapted to be fixedly connected to an unthreaded end portion of the bracing, restraining, or stabilizing pipe by means of a set screw;

FIG. 12 is a side elevational view similar to that of FIG. 5, showing, however, a fourth embodiment of an interface adaptor connector which comprises a first cap member;

FIG. 13 is a cross-sectional view of a fifth embodiment of a cap member which is adapted to serve as an interface adaptor connector interposed between, and connecting together, the bracing, restraining, or stabilizing pipe and an anchor member to be fixedly mounted within the ceiling or support beam structure of the ceiling of the building within which the water sprinkler system is installed;

FIG. 14 is a side elevational view of a sixth embodiment of an interface adaptor connector which comprises a strapping support structure and which may be utilized in lieu of the previously disclosed first cap members as the interface adaptor connector so as to be interposed between, and connect together, the bracing, restraining, or stabilizing pipe and an anchor member to be fixedly mounted within the ceiling or support beam structure of the ceiling of the building within which the water sprinkler system is installed;

FIG. 15 is a front elevational view of the support strapping structure illustrated within FIG. 14;

FIG. 16 is a perspective view of a seventh embodiment of an interface adaptor connector which comprises a mounting bracket and which may be utilized in lieu of the previously disclosed first cap members and strapping support structure as the interface adaptor connector interposed between, and connecting together, the bracing, restraining, or stabilizing pipe and an anchor member to be fixedly mounted within the ceiling or support beam structure of the ceiling of the building within which the water sprinkler system is installed;

FIG. 17 is a side elevational view showing the use of the mounting bracket illustrated within FIG. 16 when fixedly mounted upon the free or distal end portion of the bracing, restraining, or stabilizing pipe;

FIG. 18 is a front elevational view of the mounting bracket as shown in FIGS. 16 and 17 before the same is mounted upon the free or distal end portion of the bracing, restraining, or stabilizing pipe;

FIG. 19 is a front elevational view of a threaded headed bolt and washer which may be utilized in conjunction with the mounting bracket shown in FIGS. 16-18 in order to provide a connection to the anchor member to be fixedly mounted within the ceiling or support beam structure of the ceiling of the building within which the water sprinkler system is installed;

FIG. 20 is a perspective view, similar to that of FIG. 16, showing, however, an eighth embodiment of an interface adaptor connector which comprises a mounting bracket and which may be utilized in lieu of the previously disclosed first cap members, strapping support structure, and mounting bracket as the interface adaptor connector interposed between and connecting together the bracing, restraining, or stabilizing pipe and an anchor member to be fixedly mounted within the ceiling or support beam structure of the ceiling of the building within which the water sprinkler system is installed;

FIG. 21 is a side elevational view of the mounting bracket illustrated within FIG. 20 showing the use of the mounting bracket when fixedly mounted upon the free or distal end portion of the bracing, restraining, or stabilizing pipe;

FIG. 22 is a front elevational view of the mounting bracket as shown in FIGS. 20 and 21 before the same is mounted upon the free or distal end portion of the bracing, restraining, or stabilizing pipe;

FIG. 23 is a cross-sectional view similar to that of FIG. 13, showing, however, a ninth embodiment of an interface adaptor connector which comprises a cap member for threaded engagement with the free distal end portion of the bracing, restraining, or stabilizing pipe and which includes a headed bolt for connection to an anchor member to be fixedly mounted within the ceiling or support beam structure of the ceiling of the building within which the water sprinkler system is installed;

FIG. 24 is a side elevational view, similar to that of FIG. 14, showing, however, a tenth embodiment of an interface adaptor connector which comprises a strapping support structure and which may be utilized in lieu of the previously disclosed first cap members, strapping support structure, and mounting brackets as the interface adaptor connector so as to be interposed between, and connect together, the bracing, restraining, or stabilizing pipe and an anchor member to be fixedly mounted within the ceiling or support beam structure of the ceiling of the building within which the water sprinkler system is installed;

FIG. 25 is a front elevational view of the strapping support structure illustrated within FIG. 24 as the same is about to have the free or distal end portion of the bracing, restraining, or stabilizing pipe mounted within the strapping support structure; and

FIG. 26 is a perspective view of the strapping support structure and bracing, restraining, or stabilizing pipe as illustrated within FIG. 25 prior to the insertion of the bracing, restraining, or stabilizing pipe within the strapping support structure.

### DETAILED DESCRIPTION OF THE PREFERRED EMBODIMENT

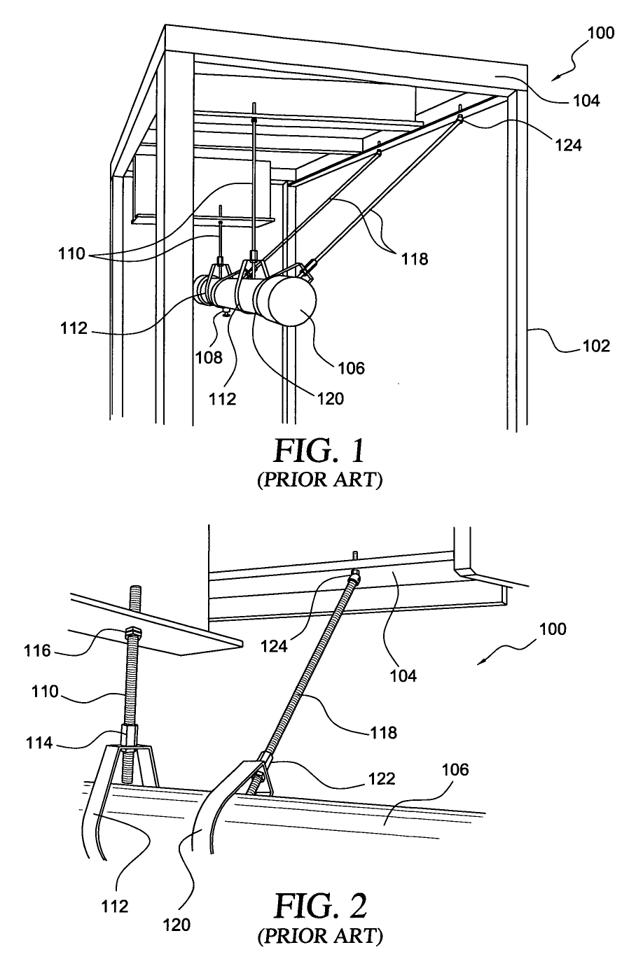

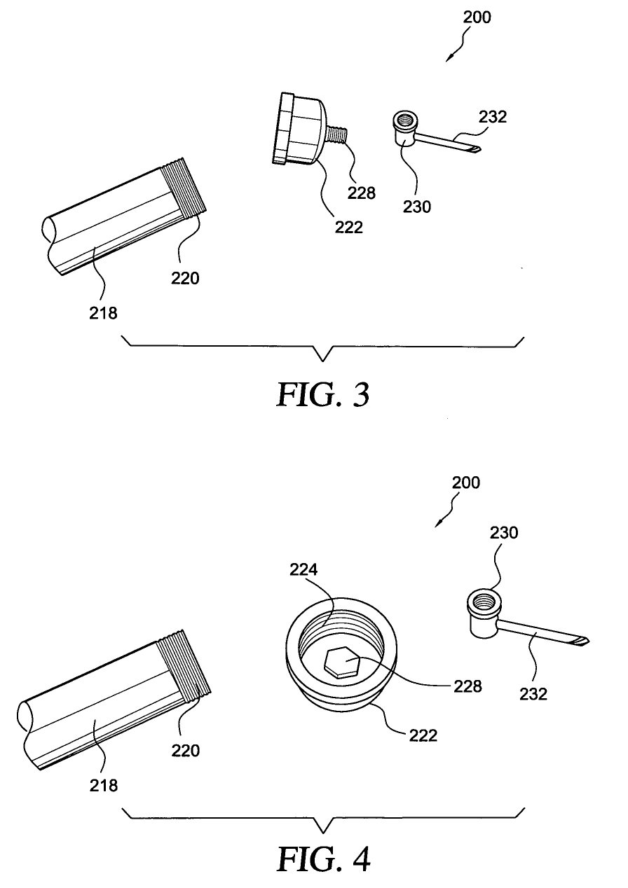

Referring now to the drawings, and more particularly to FIGS. 3-8a, a first structural embodiment of the new and improved interface adaptor connector, for effectively connecting one end of a seismic sway brace or restraint pipe, which is fixedly connected to, for example, a water pipe of a building sprinkler system, to a suitable support anchor, that is adapted to be fixedly connected to an overhead ceiling or structural beam member of a building within which the water sprinkler system has been installed, is disclosed and is generally indicated by the reference character 200. It is to be noted that, where possible, the description of the component parts, which correspond to similar component parts within the conventional system disclosed within FIGS. 1 and 2, will be designated by corresponding reference numerals, except that they will be within the 200 series. More particularly, as can best be seen from FIGS. 3,4, and 8, it is to be firstly appreciated that in lieu of the solid rod 118, conventionally employed as the bracing, restraining, or stabilizing structure within, for example, the overall system 100 for bracing, restraining, or stabilizing the water pipe 106 operatively associated with the building sprinkler system, a pipe 218 is utilized. The pipe 218 is conventionally known in the industry as a Schedule 40 one inch steel pipe, and a first end portion of the pipe 218 will be operatively connected to one of the water pipes, similar to water pipe 106, and in a manner similar to that utilized to operatively connect the end of solid rod 118 to the water pipe 106, that is, by means of a turnbuckle assembly comprising an encircling attachment strap member, and a nut member, similar to the suspension strap 112 and the nut member 122. More information concerning Schedule 40 pipes can be obtained by means of reference to the website www.engineeringtoolbox.com/ansi-steel-pipes-d_{—}305.html.

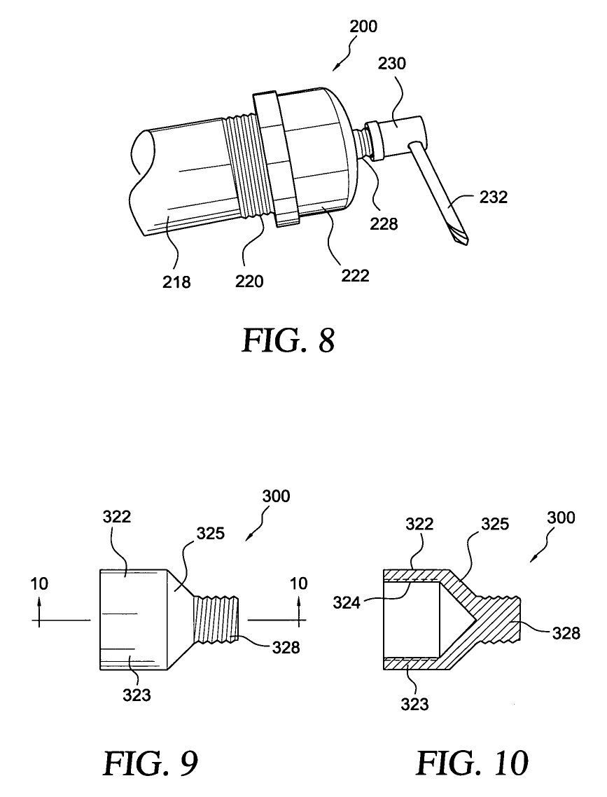

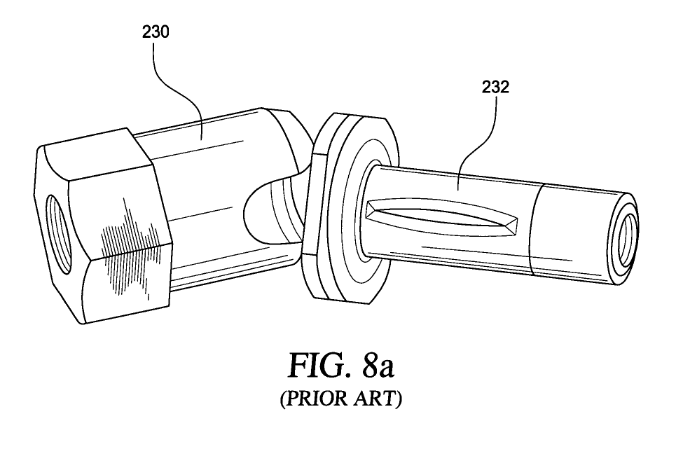

The second opposite end of the pipe 218 is externally threaded as at 220, and is adapted to be threadedly mated with a first embodiment of an interface adaptor connector which comprises a first cap member 222 having a cylindrical body portion 223 which is internally threaded as at 224. In addition, it is seen that a domed portion 225 of the first cap member 222 is provided with an internally threaded bore 226 that is adapted to threadedly receive an externally threaded stud 228. The distal or outwardly projecting end portion of the externally threaded stud 228 is adapted to be threadedly mated with a second internally threaded cap or nut member 230 which is swaged onto an end portion of a self-drilling fastener or anchor 232. The self-drilling fastener or anchor 232 is adapted to be fixedly embedded within a ceiling or support beam structure of the building within which the water sprinkler system has been installed. It is to be understood that the second cap or nut member 230 and the self-drilling fastener or anchor 232 effectively take the place of the conventional anchor 124 when the Schedule 40 pipe 218 is effectively substituted for the solid rod member 118. FIG. 8 illustrates all of the aforenoted components being assembled together, that is, the Schedule 40 pipe 218, the first cap member 222, and the externally threaded stud 228 threadedly connected to the anchor or fastening assembly comprising the second cap or nut member 230 and the self-drilling fastener or anchor 232. It is lastly noted that the threaded stud 228 can have an ex-ternal diametrical extent of either three eighths of an inch (0.375″) or one half of an inch (0.50″) in order to suitably threadedly mate with the second cap or nut member 230. A known anchor assembly, comprising the second cap or nut member 230 and the self-drilling fastener or anchor 232 is illustrated within FIG. 8a, and a complete disclosure of such an anchor assembly is disclosed within United States Patent Publication 2007/0292234.

While the components of the first structural embodiment of the new and improved interface adaptor connector 200, that is, the first cap member 222 and the externally threaded stud member 228, may be separately or individually fabricated or manufactured by means of different manufacturing techniques, operations, or processes, such as, for example, casting, cold forming, deep drawing, stamping, machining, or the like, the first cap member and the bolt member may also effectively be fabricated or manufactured as a single component in accordance with a suitable manufacturing technique or process, such as, for example, machining. As illustrated within FIGS. 9 and 10, a second embodiment of the interface adaptor connector is therefore disclosed and is generally indicated by the reference character 300, and it is to be noted that component parts of the second embodiment of the interface adaptor connector 300 which correspond to component parts of the first embodiment of the interface adaptor connector 200 will be designated by corresponding reference characters except that they will be within the 300 series. More particularly, in lieu of the first cap member 222 being cast and provided with an internally threaded bore 226 for threadedly receiving the externally threaded stud 228, as was disclosed in connection with the first embodiment of the interface adaptor connector 200, the second embodiment of the first cap member 322 may be machined as a single component having a cylindrical body portion 323 which is internally threaded as at 324. In addition, a substantially frusto-conically shaped portion 325 is integrally formed with the cylindrical body portion 323, and an axially projecting lug portion 328 is, in turn, integrally connected to the frusto-conically shaped portion 325. The lug portion 328 is adapted to be externally threaded, and accordingly, it can be threadedly connected to a second internally threaded cap member, similar to the second cap member 230, of a fastener or anchor assembly. It is to be noted that in connection with both the first and second embodiments of the interface adaptor connectors 200,300, the first cap members 222,322 can be fabricated from a suitable metal, including steel or galvanized iron, and may also be fabricated in sheet metal form.

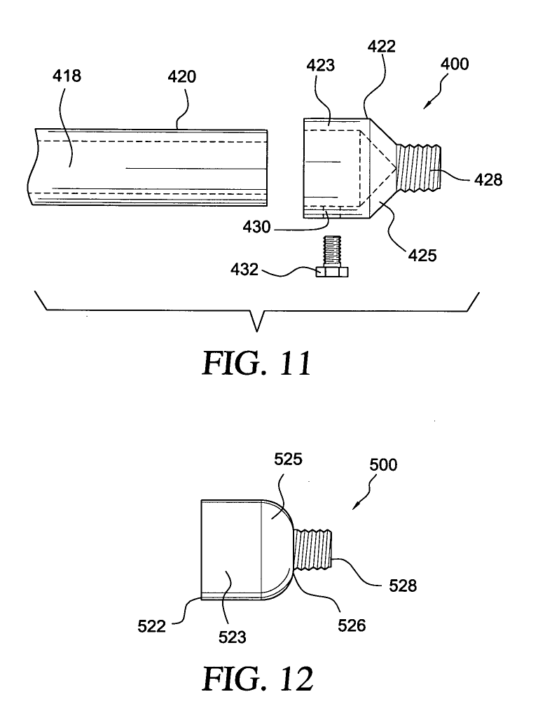

With reference now being made to FIG. 11, a third embodiment of an interface adaptor connector is disclosed and is generally indicated by the reference character 400, and it is to be noted that component parts of the third embodiment of the interface adaptor connector 400 which correspond to component parts of the first and second embodiments of the first and second interface adaptor connectors 200,300 will be designated by corresponding reference characters except that they will be within the 400 series. More particularly, while it is seen that the third embodiment of the interface adaptor connector 400 may have an external configuration somewhat similar to that of, for example, the second embodiment of the interface adaptor connector 300, the cylindrical body portion 423 of the third embodiment of the first cap member 422 is not internally threaded and is not adapted to be threadedly mated with an externally threaded end portion of the bracing, restraining, or stabilizing pipe. To the contrary, the inner peripheral wall surface of the cylindrical body portion 423 of the third embodiment of the first cap member 422 is unthreaded, and the external surface portion of the end portion 420 of the bracing, restraining, or stabilizing pipe 418 is likewise unthreaded. In addition, a sidewall portion of the cylindrical body portion 423 of the third embodiment of the first cap member 422 is provided with an internally threaded through-bore 430, and a set screw 432 is adapted to be threadedly engaged within the internally threaded through-bore 430. Accordingly, when the unthreaded end portion 420 of the bracing, restraining, or stabilizing pipe 418 is inserted internally into the unthreaded cylindrical body portion 423 of the third embodiment of the first cap member 422, the disposition of the unthreaded end portion 420 of the bracing, restraining, or stabilizing pipe 418 can be fixedly secured within the unthreaded cylindrical body portion 423 of the third embodiment of the first cap member 422 as a result of the set screw 432 tightly engaging an external peripheral surface portion of the unthreaded end portion 420 of the bracing, restraining, or stabilizing pipe 418.

With reference now being made to FIG. 12, a fourth embodiment of an interface adaptor connector is disclosed and is generally indicated by the reference character 500, and it is to be noted that component parts of the fourth embodiment of the interface adaptor connector 500 which correspond to component parts of the first, second, and third embodiments of the interface adaptor connectors 200,300,400 will be designated by corresponding reference characters except that they will be within the 500 series. More particularly, it is to be noted that in accordance with the teachings and principles of this fourth embodiment of the interface adaptor connector 500, in lieu of the cylindrical body portion 523 and the domed section 525 of the cap member 522 comprising a single piece structure, the cylindrical body portion 523 may simply comprise a hollow tube member which may, for example, be internally threaded so as to be able to threadedly mate with the externally threaded end portion of a bracing, restraining, or stabilizing pipe similar to bracing, restraining, or stabilizing pipe 218, whereas the domed portion 525 would then comprise a separate structure which could be crimped, welded, or swaged onto the cylindrical body portion 523 of the hollow tube member such that the cylindrical body portion 523 and the domed portion 525 together define the first cap member 522. The domed portion 525 could, in turn, be provided with an internally threaded through-bore 526 for threadedly accommodating a stud member 528 which can, in turn, be threadedly mated with an internally threaded second cap member similar to that shown at 230 within FIGS. 3,4, and 8.

Alternatively, an integral stud member 528 could effectively be formed in conjunction with the domed portion 525 in a manner similar to that disclosed within FIGS. 9 and 10. Alternatively, and still further, the cylindrical body portion 523 of the hollow tube member need not be internally threaded so as to threadedly mate with an externally threaded end portion of the bracing, restraining, or stabilizing pipe, but, to the contrary, the internal peripheral surface portion of the cylindrical body portion 523 of the hollow tube member may be unthreaded, and a side wall portion of the cylindrical body portion 523 of the hollow tube member may have a through-bore formed therewithin so as to receive a set screw, similar to the set screw 432 disclosed within FIG. 11, so as to tightly contact and engage the externally unthreaded end portion of the bracing, restraining, or stabilizing pipe when the same is inserted into the open end portion of the cylindrical body portion 523 of the hollow tube member. Lastly, it is also envisioned that in connection with this last embodiment of the interface adaptor connector 500, as well as in connection with the interface adaptor connector 400 as illustrated within FIG. 11, the circumferential extent of the cylindrical body portions 423,523 need not be perfectly circular or that of a true cylinder. To the contrary, the cross-sectional configuration of the body portions 423,523 may actually comprise that of an oval or ellipse such that the body portions 423,523 would then have to be installed upon the externally unthreaded portions of the bracing, restraining, or stabilizing pipe by means of a force-fit or interference fit.

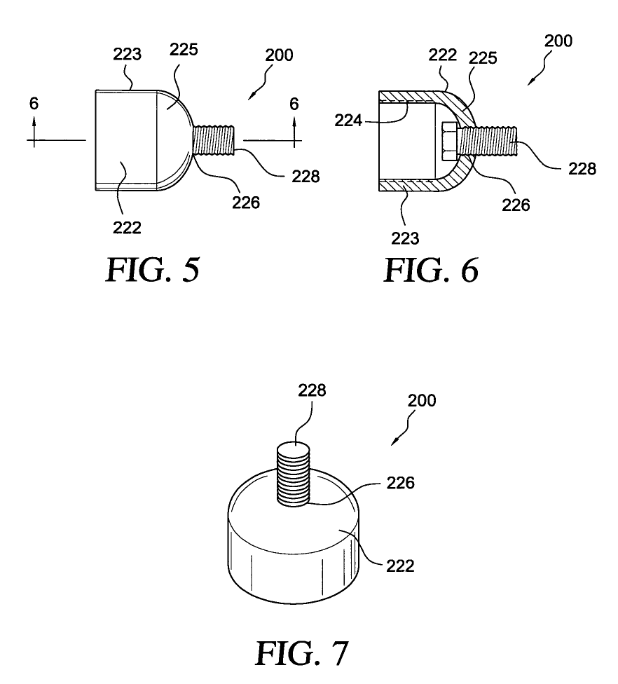

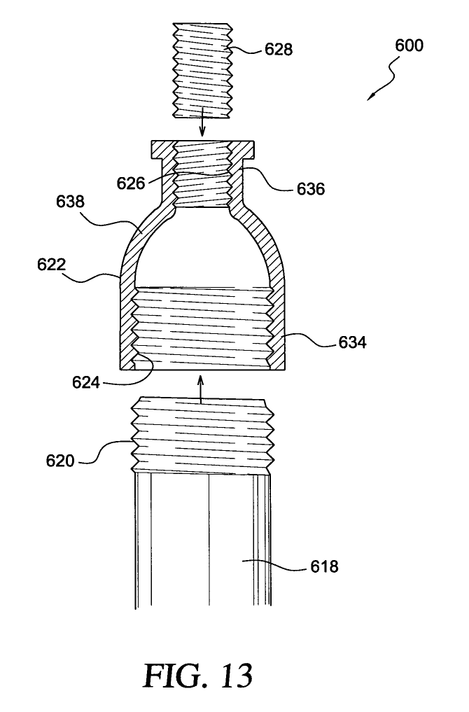

With reference now being made to FIG. 13, a fifth embodiment of an interface adaptor connector is disclosed and is generally indicated by the reference character 600, and it is to be noted that component parts of the fourth embodiment of the interface adaptor connector 600 which correspond to component parts of the first, second, third, and fourth embodiments of the interface adaptor connectors 200,300,400,500 will be designated by corresponding reference characters except that they will be within the 600 series. More particularly, it is seen that, in a manner similar to the interface adaptor connector 200 shown in FIGS. 5 and 6, in lieu of the first cap member 622 comprising a substantially cylindrical body portion 223 and a domed portion 225, as was the case with the first embodiment of the interface adaptor connector 200, the first cap member 622 is seen to comprise a reduced diameter coupling member having a first relatively large, substantially cylindrical end portion 634 which is internally threaded as at 624, and a second relatively small, substantially cylindrical end portion 636 which is internally threaded as at 626. A smoothly contoured transition portion 638 is interposed between the first and second end portions 634,636 so as to smoothly and continuously interconnnect the same together, and it is seen that the first relatively large internally threaded end portion 634 is adapted to be threadedly mated with an externally threaded end portion 620 of a bracing, restraining, or stabilizing pipe 618, while the second relatively small internally threaded end portion 636 is adapted to threadedly accommodate an externally threaded stud member 628 which will, in turn, be threadedly mated with a second cap member of a fastener anchor assembly similar to that shown at 230 within FIGS. 3,4, and 8. It is also to be appreciated that the stud member 628 may be fixedly secured within the relatively small end portion 636 of the cap member 622 by means of a suitable adhesive, such as, for example, LOCTITE®.

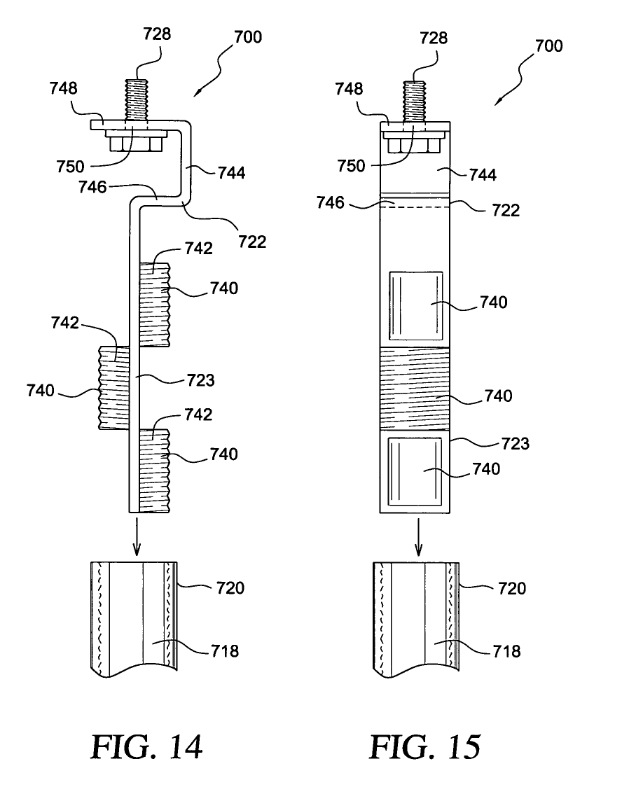

With reference now being made to FIGS. 14 and 15, a sixth embodiment of an interface adaptor connector is disclosed and is generally indicated by the reference character 700, and it is to be noted that component parts of the sixth embodiment of the interface adaptor connector 700 which correspond to component parts of the first, second, third, fourth, and fifth embodiments of the interface adaptor connectors 200,300,400,500,600 will be designated by corresponding reference characters except that they will be within the 700 series. In accordance with the principles and teachings of the sixth embodiment of the interface adaptor connector 700, in lieu of the previously disclosed first cap members, the sixth embodiment interface adaptor connector 700 is seen to comprise an axially elongated steel strapping support structure 722 which comprises a substantially central or axial body portion 723, and a plurality of axially spaced, radially or transversely outwardly extending pocket or cup-shaped projections 740 that are punched or stamped out from the material comprising the body portion 723, two of the axially spaced projections 740 extending outwardly toward the right as viewed in FIG. 14, and an intermediate one of the axially spaced projections 740 extending outwardly toward the left as viewed in FIG. 14.

The projections are externally threaded as at 742, and are adapted to threadedly mate with an internally threaded end portion 720 of a bracing, restraining, or stabilizing pipe 718 when the body portion 723 of the structure 722 of the interface adaptor connector 700 is inserted into the end portion 720 of the bracing, restraining, or stabilizing pipe 718. At the upper end portion of the body portion 723 of the structure 722 of the interface adaptor connector 700, a support member 744, having a substantially reversed C-shaped cross-sectional configuration, is integrally connected to the upper end region of the body portion 723 of the structure 722 of the interface adaptor connector 700 by means of its lower leg member 746, while the upper leg member 748 of the reversed C-shaped support member 744 has am internally threaded through-bore 750 defined therein for accommodating an externally threaded headed bolt member 728 which is adapted to be threadedly connected to a cap member of a fastener anchor assembly similar to that illustrated at 230 within FIGS. 3,4, and 8. Alternatively, the bore 750 may be unthreaded and the headed bolt 728 may be fixedly mounted within the bore 750 of the upper leg member 748 by means of a nut member press-fitted or interference fitted within the 750 bore.

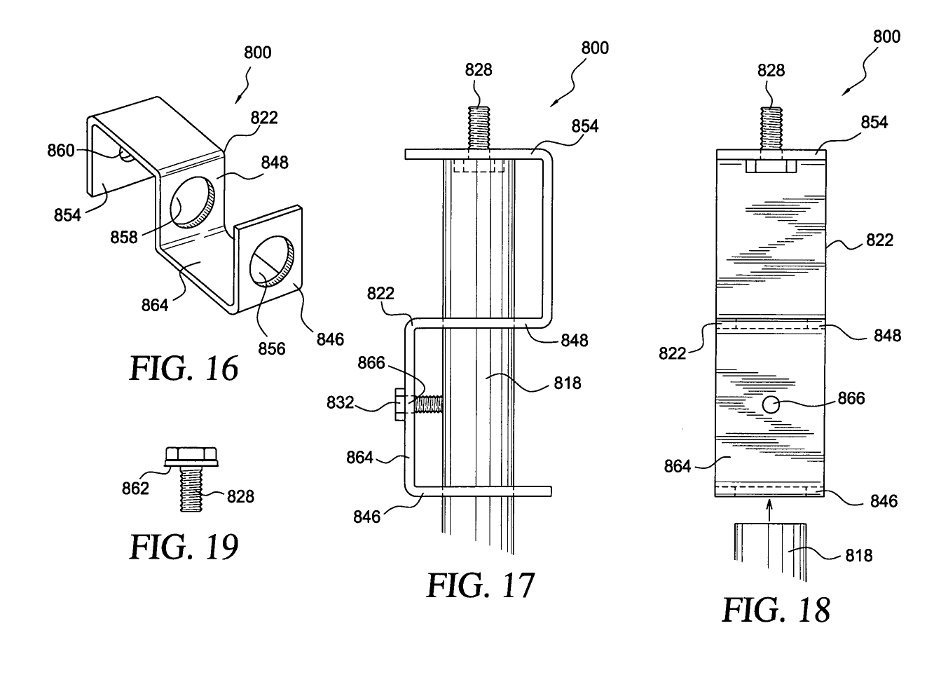

Referring now to FIGS. 16-19, a seventh embodiment of an interface adaptor connector is disclosed and is generally indicated by the reference character 800, and it is to be noted that component parts of the seventh embodiment of the interface adaptor connector 800 which correspond to component parts of the first, second, third, fourth, fifth, and sixth embodiments of the interface adaptor connectors 200, 300,400,500,600,700 will be designated by corresponding reference characters except that they will be within the 800 series. In accordance with the principles and teachings of the seventh embodiment of the interface adaptor connector 800, it is noted that the seventh embodiment interface adapt- or connector 800 is somewhat similar to that sixth embodiment interface adaptor connector 700 as illustrated within FIGS. 14 and 15, except that the seventh embodiment interface adaptor connector 800 comprises a steel strapping structure 822 which effectively comprises a mounting bracket and has a substantially S-shaped cross-sectional configuration wherein the leg members 846,848,854 are respectfully provided with a plurality of axially aligned through-bore 856,858,860 wherein each of the through-bores 856,858,860 is effectively smooth and not tapped or internally threaded.

Accordingly, the bracing, restraining, or stabilizing pipe 818, the external surface of which is also smooth and does not have an externally threaded end portion defined thereon, can be inserted through the bores 856 and 858, however, the end of the bracing, restraining, or stabilizing pipe 818 does not project through the uppermost one of the through-bores 860, but to the contrary, abuts the undersurface portion of the leg member 854, as can best be appreciated from FIG. 17. In addition, as can best be appreciated from FIG. 19, an externally threaded headed bolt member 828 has a nut member 862 operatively associated therewith. The nut member 862 is adapted to be press-fitted or interference-fitted within the uppermost through-bore 860 such that the bolt member 828 can be fixedly mounted within the uppermost through-bore 860 and be ready for threaded engagement with a second cap member of a fastener anchor assembly similar to that illustrated at 230 within FIGS. 3,4, and 8. Still yet further, it is seen that the portion 864, which effectively interconnects the leg members 846,848, has an internally threaded aperture or through-bore 866 defined therein for receiving a set screw 832 therewithin. The set screw 832 is adapted to tightly engage an outer peripheral surface portion of the bracing, restraining, or stabilizing pipe 818 in order to fixedly secure the bracing, restraining, or stabilizing pipe 818 at its desired axial disposition with respect to the steel stamping structure 822.

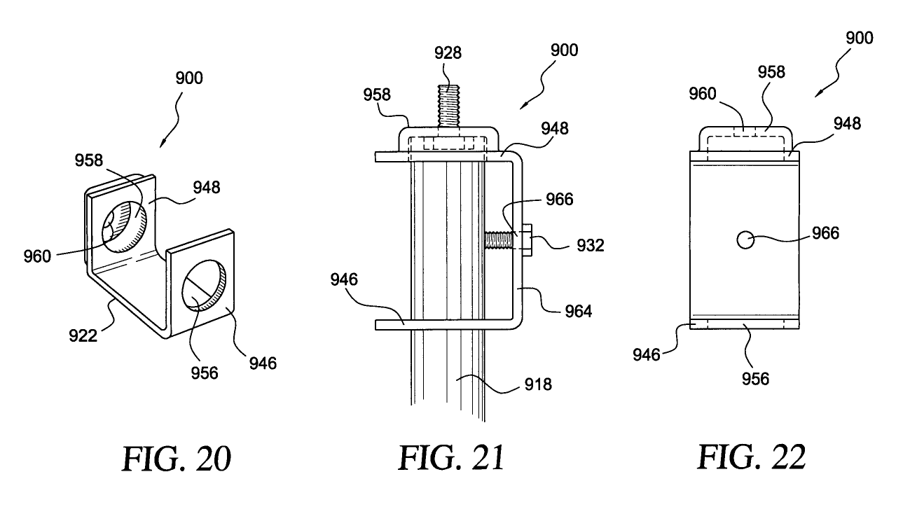

With reference now being made to FIGS. 20-22, an eighth embodiment of an interface adaptor connector is disclosed and is generally indicated by the reference character 900, and it is to be noted that component parts of the eighth embodiment of the interface adaptor connector 900 that correspond to component parts of the first, second, third, fourth, fifth, sixth, and seventh embodiments of the interface adapt- or connectors 200,300,400,500,600,700,800 will be designated by corresponding reference characters except that they will be within the 900 series. It can also be readily appreciated that the eighth embodiment interface adaptor connector 900 is somewhat similar to the seventh embodiment interface adaptor connector illustrated within FIGS. 16-19 except as will be hereinafter described, and the description will be limited to such differences for brevity purposes. More particularly, the primary difference between the seventh embodiment interface adaptor connector 800 as illustrated in FIGS. 16-19, and the eighth embodiment interface adaptor connector 900 illustrated within FIGS. 20-22 resides in the fact that the eighth embodiment interface adaptor connector 900 comprises a steel strapping structure or mounting bracket 922 having a substantially C-shaped cross-sectional configuration wherein the leg members 946 and 948 are respectfully provided with a through-bore 956 and an upwardly extending countersunk region 958 within which an internally threaded bore 960 is provided for the threadedly receiving a threaded bolt 928 which will, in turn, threadedly engage a second cap member of a fastener anchor assembly similar to that illustrated at 230 within FIGS. 3,4, and 8. Alternatively, the externally threaded headed bolt member 928 can have a nut member operatively associated therewith wherein the nut member is adapted to be press-fitted or interference-fitted within the bore 960 such that the bolt member 928 can be fixedly mounted within the bore 960 and be ready for threaded engagement with a second cap member of a fastener anchor assembly similar to that illustrated at 230 within FIGS. 3,4, and 8. The through-bore 956 is effectively smooth and not tapped or internally threaded. Accordingly, the bracing, restraining, or stabilizing pipe 918, the external surface of which is also smooth and does not have an externally threaded end portion defined thereon, can be inserted through the bore 956, however, the end of the bracing, restraining, or stabilizing pipe 918 is seated within the annular countersunk region 958 of the upper leg member 948, as can best be appreciated from FIG. 21. Still yet further, it is seen that the portion 964, which effectively interconnects the leg members 946,948, has an internally threaded aperture or through-bore 966 defined therein for receiving a set screw 932 therewithin. The set screw 932 is adapted to tightly engage an outer peripheral surface portion of the bracing, restraining, or stabilizing pipe 918 in order to fixedly secure the bracing, restraining, or stabilizing pipe 918 at its desired axial disposition with respect to the steel stamping structure 922.

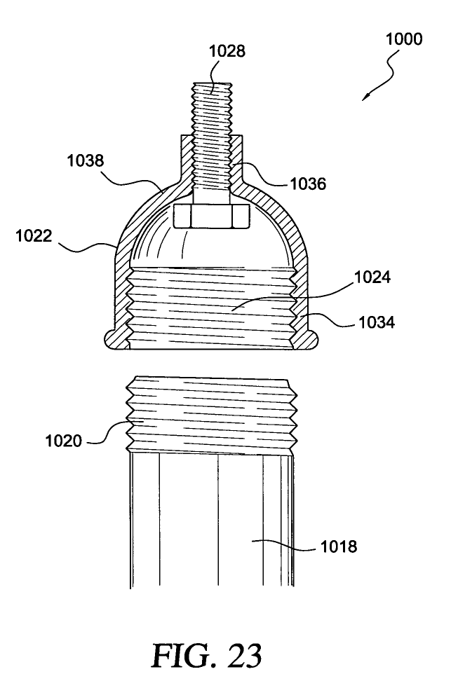

With reference now being made to FIG. 23, a ninth embodiment of an interface adaptor connector is disclosed and is generally indicated by the reference character 1000, and it is to be noted that component parts of the ninth embodiment of the interface adaptor connector 1000 that correspond to component parts of the first, second, third, fourth, fifth, sixth, seventh, and eighth embodiments of the interface adaptor connectors 200,300,400,500,600,700,800,900 will be designated by corresponding reference characters except that they will be within the 1000 series. It can also be readily appreciated that the ninth embodiment interface adaptor connector 1000 is somewhat similar to the fifth embodiment interface adaptor connector illustrated within FIG. 13 except as will be hereinafter described, and the description will be limited to such differences for brevity purposes. More particularly, it is seen that, in a manner similar to the interface adaptor connector 600 shown in FIG. 13, the primary difference between the fifth embodiment interface adaptor connector 600 shown in FIG. 13 and the ninth embodiment interface adaptor connector 1000 shown in FIG. 23 resides in the fact that in lieu of the externally threaded stud member 628, an externally threaded headed bolt member 1028 may be employed. It is to be noted that the relatively small end portion 1036 of the first cap member 1022 may be internally threaded so as to threadedly interface with the externally threaded bolt member 1028, or alternatively, the bolt member 1028 may be inserted through the unthreaded end portion 1036 and fixedly secured therewithin by means of a suitable nut member, not shown.

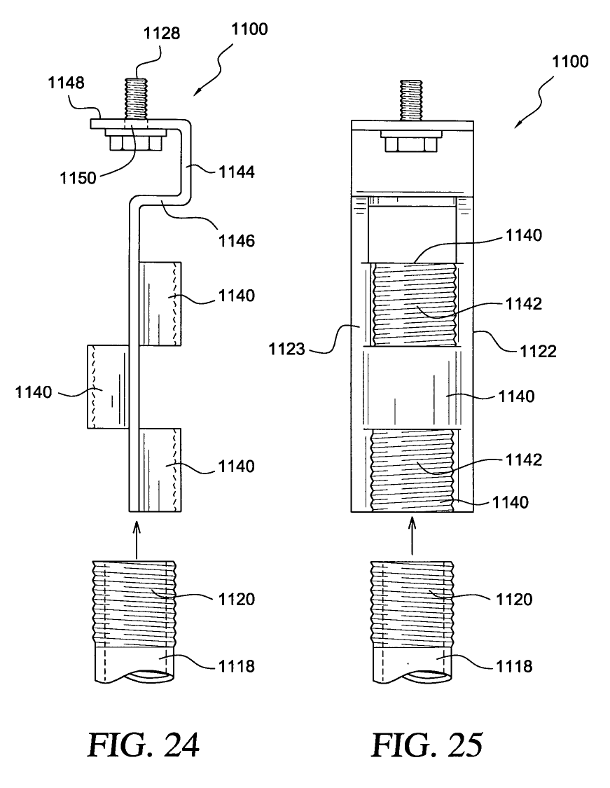

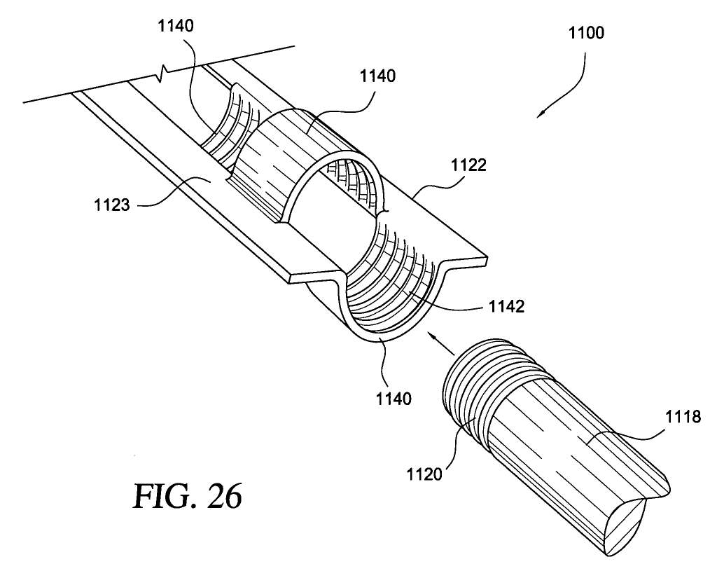

Lastly, with reference being made to FIGS. 24-26, a tenth embodiment of an interface adaptor connector is disclosed and is generally indicated by the reference character 1100, and it is to be noted that component parts of the tenth embodiment of the interface adaptor connector 1100 that correspond to component parts of the first, second, third, fourth, fifth, sixth, seventh, eighth, and ninth embodiments of the interface adaptor connectors 200,300,400,500,600,700, 800,900,1000 will be designated by corresponding reference characters except that they will be within the 1100 series. It can also be readily appreciated that the tenth embodiment interface adaptor connector 1100 is somewhat similar to the sixth embodiment interface adaptor connector illustrated within FIGS. 14-15 except as will be hereinafter described, and the description will be limited to such differences for brevity purposes. More particularly, the primary difference between the sixth embodiment interface adaptor connector 700 as illustrated within FIGS. 14-15, and the tenth embodiment interface adaptor connector 1100 illustrated within FIGS. 24-26 resides in the fact that the plurality of axially spaced, radially or transversely outwardly extending projections 1140, formed upon the body portion 1123 of the elongated interface adaptor connector strapping structure 1122 do not comprise stamped or punched out enclosed pockets or cup-shaped projections as was the case with the pockets or cup-shaped projections 740, but, to the contrary, the projections 1140 comprise punched or stamped out projections effectively having semi-cylindrical configurations as can best be appreciated from FIG. 26 so as to in effect define a substantially cylindrical channel within which the bracing, restraining, or stabilizing pipe 1118 can be inserted.

The projections 1140 are internally threaded as at 1142, and are adapted to threadedly mate with an externally threaded end portion 1120 of a bracing, restraining, or stabilizing pipe 1118 when the externally threaded end portion 1120 of the bracing, restraining, or stabilizing pipe 1118 is inserted into the aforenoted channel portion of the body portion 1123 of the structure 1122 of the interface adaptor connector 1100. As was the case with the sixth embodiment of the interface adaptor connector 700, the upper end portion of the body portion 1123 of the structure 1122 of the tenth embodiment of the interface adaptor connector 1100 is provided with a support member 1144, having a substantially reversed C-shaped cross-sectional configuration, and is integrally connected to the upper end region of the body portion 1123 of the structure 1122 of the interface adaptor connector 1100 by means of its lower leg member 1146, while the upper leg member 1148 of the reversed C-shaped support member 1144 has am internally threaded through-bore 1150 defined therein for accommodating an externally threaded headed bolt member 1128 that is adapted to be threadedly connected to a cap member of a fastener anchor assembly similar to that illustrated at 230 within FIGS. 3,4, and 8. Alternatively, the bore 1150 may be unthreaded and the headed bolt 1128 may be fixedly mounted in the bore 1150 of the upper leg member 1148 by means of a nut member press-fitted or interference fitted within the 1150 bore.

Thus, it may be appreciated that in accordance with the principles and teachings of the present invention, there has been disclosed various embodiments of a new and improved interface adaptor connector for effectively connecting one end of a seismic sway brace or restraint pipe, which is fixedly connected to, for example, a water pipe of a building sprinkler system, to a suitable support anchor that is adapted to be fixedly connected to an overhead ceiling or structural beam member of a building within which the sprinkler system has been installed.

Obviously, many variations and modifications of the present invention are possible in light of the above teachings. It is therefore to be understood that within the scope of the appended claims, the present invention may be practiced otherwise than as specifically described herein.

What is claimed is:

1. An interface adaptor connector for connecting one end of a sway brace/restraint pipe, adapted to restrain movements of a component to which the sway brace/restraint pipe is connected, to an anchor assembly, comprising:
an interface adaptor connector having a first end portion configured to mate with a free distal end portion of a sway brace/restraint pipe, and a second end portion which is adapted to mate with an anchor assembly such that the sway brace/restraint pipe, said interface adaptor connector, and the anchor assembly will effectively prevent the component from undergoing any substantial movements when subjected to external forces.

2. The interface adaptor connector as set forth in claim 1, wherein said interface adaptor connector comprises:
a first cap member and a stud/bolt member for respectively interfacing with and connection to the sway brace restraint pipe and the anchor assembly.

3. The interface adaptor connector as set forth in claim 2, wherein:
said first cap member is internally threaded at a first end portion thereof so as to be threadedly engaged with an externally threaded end portion of the sway brace/restraint pipe, and is internally threaded at a second end portion thereof so as to be threadedly connected to a first end portion of said stud/bolt member; and
said stud/bolt is externally threaded at said first end portion thereof so as to be threadedly engaged with said second internally threaded end portion of said first cap member, and is externally threaded at a second end portion thereof so as to be threadedly engaged with a second cap/nut member of the anchor assembly.

4. The interface adaptor connector as set forth in claim 2, wherein:
said interface adaptor connector, comprising said first cap member and said stud/bolt member, comprises an integral one-piece assembly for respectively interfacing with and connection to the sway brace/restraint pipe and the anchor assembly.

5. The interface adaptor connector as set forth in claim 2, wherein:
said first cap member is internally unthreaded at a first end portion thereof so as to receive an end portion of the sway brace/restraint pipe therewithin, and has a threaded bore defined within a side wall section of a body portion of said first cap member; and
a set screw is threadedly engaged within said threaded bore defined within said side wall portion of said body portion of said first cap member so as to tightly engage an external peripheral wall portion of the sway brace/restraint pipe when the sway brace/restraint pipe is disposed within said first unthreaded end portion of said first cap member.

6. The interface adaptor connector as set forth in claim 2, wherein:
said first cap member comprises a single piece, reduced diameter coupling member having a first relatively large diameter internally threaded end portion for threaded engagement with the sway brace/restraint pipe, a second relatively small diameter internally threaded end portion for threaded engagement with said stud-bolt member, and a smoothly contoured transition portion interconnecting said first relatively large diameter internally threaded end portion to said second relatively small diameter internally threaded end portion.

7. The interface adaptor connector as set forth in claim 1, wherein said interface adaptor connector comprises:
an axially elongated strapping support structure having radially outwardly extending projections which are externally threaded so as to threadedly engage an internally threaded portion of the sway brace/restraint pipe.

8. The interface adaptor connector as set forth in claim 1, wherein said interface adaptor connector comprises:
an axially elongated strapping support structure having radially outwardly extending projections which are internally threaded so as to threadedly engage an externally threaded portion of the sway brace/restraint pipe.

9. The interface adaptor connector as set forth in claim 8, wherein:
said radially outwardly extending, internally threaded, projections together define a substantially cylindrical tunnel within which the sway brace/restraint pipe is accommodated.

10. The interface adaptor connector as set forth in claim 1, wherein said interface adaptor connector comprises:
a mounting bracket having a substantially S-shaped cross-sectional configuration comprising three leg members;
a plurality of axially aligned through-bores defined within said three leg members of said substantially S-shaped mounting bracket for permitting the sway brace/restraint pipe to be disposed therewithin;
a threaded bore defined within a portion of said substantially S-shaped mounting bracket which connects together two of said three leg members; and
a set screw threadedly engaged within said threaded bore so as to tightly engage the sway brace/restraint pipe when the sway brace/restraint pipe is disposed within said axially aligned through-bores of said substantially S-shaped mounting bracket.

11. The interface adaptor connector as set forth in claim 1, wherein said interface adaptor connector comprises:
a mounting bracket having a substantially C-shaped cross-sectional configuration comprising a pair of leg members;
at least one through-bores defined within at least one of said pair of leg members of said substantially C-shaped mounting bracket for permitting the swaybrace/restraint pipe to be disposed therewithin;
a threaded bore defined within a portion of said substantially C-shaped mounting bracket which connects together said pair of leg members; and
a set screw threadedly engaged within said threaded bore so as to tightly engage the sway brace/restraint pipe when the sway brace/restraint pipe is disposed within said axially aligned through-bores of said substantially S-shaped mounting bracket.

12. In combination, a sway brace/restraint pipe, adapted to brace/restrain movements of a component, and an interface adaptor connector for connecting one end of said sway brace/restraint pipe to a support anchor, comprising:
a sway brace/restraint pipe;
an anchor assembly which is adapted to be fixedly mounted within a support member; and
an interface adaptor connector having a first end portion, which is configured to mate with a free distal end portion of said sway brace/restraint pipe, and a second end portion which is adapted to mate with said anchor assembly such that said sway brace/restraint pipe, said interface adaptor connector, and said anchor assembly will effectively prevent the component from undergoing any substantial movements when subjected to external forces.

13. The combination as set forth in claim 12, wherein:
said sway brace/restraint pipe comprises a Schedule 40 one inch diameter steel pipe.

14. The combination as set forth in claim 12, wherein:
said interface adaptor connector comprises a first cap member and a stud/bolt member for respectively interfacing with and connection to said sway brace/restraint pipe and said anchor assembly.

15. The combination as set forth in claim 14, wherein:
said anchor assembly comprises a second cap/nut member adapted to be threadedly connected to said stud-bolt member of said interface adaptor connector.

16. The combination as set forth in claim 12, wherein said interface adaptor connector comprises:
an axially elongated strapping support structure having radially outwardly extending projections which are externally threaded so as to threadedly engage an internally threaded portion of said sway brace/restraint pipe.

17. The combination as set forth in claim 12, wherein said interface adaptor connector comprises:
an axially elongated strapping support structure having radially outwardly extending projections which are internally threaded so as to threadedly engage an externally threaded portion of said sway brace/restraint pipe.

18. The combination as set forth in claim 12, wherein said interface adaptor connector comprises:
a mounting bracket having a substantially S-shaped cross-sectional configuration comprising three leg members;
a plurality of axially aligned through-bores defined within said three leg members of said substantially S-shaped mounting bracket for permitting the sway brace/restraint pipe to be disposed therewithin;
a threaded bore defined within a portion of said substantially S-shaped mounting bracket which connects together two of said three leg members; and
a set screw threadedly engaged within said threaded bore so as to tightly engage the sway brace/restraint pipe when the sway brace/restraint pipe is disposed within said axially aligned through-bores of said substantially S-shaped mounting bracket.

19. The combination as set forth in claim 12, wherein said interface adaptor connector comprises:
a mounting bracket having a substantially C-shaped cross-sectional configuration comprising a pair of leg members;
at least one through-bores defined within at least one of said pair of leg members of said substantially C-shaped mounting bracket for permitting the sway brace/restraint pipe to be disposed therewithin;
a threaded bore defined within a portion of said substantially C-shaped mounting bracket which connects together said pair of leg members; and
a set screw threadedly engaged within said threaded bore so as to tightly engage the sway brace/restraint pipe when the sway brace/restraint pipe is disposed within said axially aligned through-bores of said substantially S-shaped mounting bracket.

20. An interface adaptor connector for connecting one end of a seismic sway brace/restraint pipe, for use in connection with a water pipe of a building sprinkler system, to a support anchor which is adapted to be fixedly connected to an overhead ceiling of the building within which the sprinkler system has been installed, comprising:
an interface adaptor connector having a first end portion configured to mate with a free distal end portion of a sway brace/restraint pipe which is fixedly connected at its other end portion to a water pipe of a water sprinkler system, and a second end portion which is adapted to mate with an anchor assembly which is adapted to be fixedly mounted within a support member such that the sway brace/restraint pipe, said interface adaptor connector, and the anchor assembly will effectively prevent the water pipe of the water sprinkler system from undergoing substantial movements when subjected to forces attendant naturally occurring seismic events and man-made events.
